(19) United States
(12) Patent Application Publication
(10) Pub. No.: US 2010/0235646 A1
(43) Pub. Date: Sep. 16, 2010

(54) Verification method and system thereof

(75) Inventors: Tong-Long Fu, Taipei (TW); Sheng-Lung Li, Taipei (TW)

Correspondence Address: HUDAK, SHUNK & FARINE, CO., L.P.A., 2020 FRONT STREET, SUITE 307, CUYAHOGA FALLS, OH, 44221, US

(73) Assignee: EGIS TECHNOLOGY INC., TAIPEI (TW)

(21) Appl. No.: 12/661,075

(22) Filed: Mar. 10, 2010

Related U.S. Application Data
(60) Provisional application No. 61/159,807, filed on Mar. 13, 2009.

(51) Int. Cl. G06F 21/00; G06F 9/445; G06F 9/24

(52) U.S. Cl. 713/186

(57) ABSTRACT

A verification method and a verification system are disclosed. The verification method is applicable to an electronic device including a system memory and a BIOS memory provided with a Pre-Boot Authentication (PBA) application and prescribed biometric data. In one embodiment, the verification method comprises the steps of executing a BIOS process to load the operation code (OPCode) or the BIOS driver of the BIOS from the BIOS memory to the system memory to establish a communication channel between the electronic device and a biometric device; loading the PBA application to the system memory for running; loading the prescribed biometric data to the system to compare with biometric data acquired by the biometric data capture device; and requesting the BIOS to load an operation system when the comparing result is matched.

### BACKGROUND OF THE INVENTION

1. Field of the Invention

The exemplary embodiment(s) of the present invention relates to a field of verification method and verification system thereof. More specifically, the exemplary embodiment(s) of the present invention relates to a verification method and verification system based on a BIOS process before running an operation system.

2. Description of Related Art

The use of biometrics as an aid to confirming authorization for access to various types of resources or locations has been increasing. Biometric systems measure various unique or nearly unique characteristics of a person's body to assist in confirming identity, and consequently in authorizing an access requested by the person. Common body characteristics used in these systems include fingerprints and eye retinal patterns.

Fingerprints are believed by many to be unique or nearly unique across the population base. Fingerprints include ridges/furrows that define a complex pattern. Each fingerprint typically includes many pattern features that are cognizable by detection systems. These pattern features serve as the basis by which many fingerprint biometric systems judge a match between a fingerprint-under-test and a reference fingerprint. That is, when the system determines that there is a sufficient match between the fingerprint-under-test and the reference, the system has determined that there are enough matching minutia between the two.

Most conventional verification systems are operated in an electronic device under the environment of an operation system to perform the verification. However, a problem associated with the conventional verification systems is that the authentication database of the verification system needs to be reconstructed when the operation system is reinstalled. Also, the authentication database accessed by the operation system may lead to a security concern because the operation system with insufficient protect capability if the electronic device is hacked via the backdoor of the operation system.

### SUMMARY OF THE INVENTION

In view of the aforementioned problems of the prior art, one objective of the present invention is to provide a verification method and system thereof to perform a verification process via accessing the BIOS of an electronic device.

According to the objective, the present invention provides a verification method applicable to an electronic device provided with a system memory and a Basic Input/Output

System (BIOS) memory having a Pre-Boot Authentication (PBA) application and prescribed biometric data, the verification method comprising the steps. Execute a BIOS process to load the operation code (OPCode) or the BIOS driver of the BIOS from the BIOS memory to the system memory to communicate the electronic device with a biometric data capture device. Load the prescribed biometric data to the system memory and acquire biometric data captured by the biometric capture device to temporarily store in the system memory. Compare the biometric data with the prescribed biometric data in the system memory by utilizing the PBA application. And, request the BIOS to load an operation system through the PBA application when the comparing result is matched.

According to the objective, a verification system is provided, comprising a BIOS memory, a system memory, a biometric data capture device and a processing module. The BIOS memory is arranged for storing a pre-boot authentication (PBA) application and prescribed biometric data. The biometric data capture device is arranged for acquiring biometric data. The processing module is connected to the BIOS memory, the system memory and the biometric data capture device. A BIOS process is executed by the processing module to load the OPCode or the BIOS driver of the BIOS from the BIOS memory to the system memory to communicate with the image capture device. The PBA application is run to load the prescribed biometric data from the BIOS memory to the system memory and acquire the biometric data to the system memory. The PBA application compares the biometric data with the prescribed biometric data in the system memory to request the BIOS to load an operation system when the comparing result is matched.

As described above, the verification method and system thereof according the present invention may have the following advantages:
(1) The verification method and system thereof may provide convenience to reinstall the operation system without reconstructing the authentication database.
(2) The verification method and system thereof may increase the security of accessing the authentication database by performing the verification process under the BIOS process environment.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 illustrates a schematic view of the preferred embodiment of a verification system according to the present invention;

FIG. 2 illustrates a flow chart of the implementation steps of a first embodiment of a verification method according to the present invention; and

FIG. 3 illustrates a flow chart of the implementation steps of a second embodiment of a verification method according to the present invention.

### DETAILED DESCRIPTION OF THE PREFERRED EMBODIMENTS

Exemplary embodiments of the present invention are described herein in the context of a verification method and system thereof.

Those of ordinary skilled in the art will realize that the following detailed description of the exemplary embodiment(s) is illustrative only and is not intended to be in any way limiting. Other embodiments will readily suggest themselves to such skilled persons having the benefit of this disclosure. Reference will now be made in detail to implementations of the exemplary embodiment(s) as illustrated in the accompanying drawings. The same reference indicators will be used throughout the drawings and the following detailed description to refer to the same or like parts.

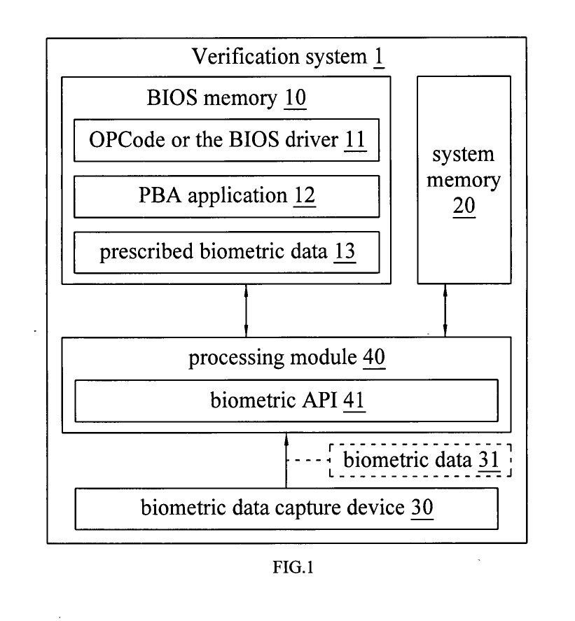

Referring to FIG. 1, a schematic view of the preferred embodiment of a verification system according to the present invention is illustrated. In this figure, the verification system 1 comprises a BIOS memory 10, a system memory 20, a biometric data capture device 30 and a processing module 40. The operation code or the BIOS driver 11, a pre-boot authentication (PBA) application 12 and the prescribed biometric data 13 are stored in the BIOS memory 10. The biometric data capture device 30 is utilized to acquire biometric data 31. A BIOS process is executed by the processing module 40 to load the OPCode or the BIOS driver 11 from the BIOS memory 10 to the system memory 20 to communicate with the biometric data capture device 30. The PBA application 12 is loaded to the system memory 20 from the BIOS memory 10 and the PBA application 12 in the BIOS memory 10 is run in order to load the prescribed biometric data 13 from the BIOS memory 10 to the system memory 20 and acquire the biometric data 31 to temporarily store in the system memory 20. The PBA application 12 is also used to compare the prescribed biometric data 13 with the biometric data 31 for requesting the BIOS to load an operation system when the comparing result is matched.

Preferably, the BIOS is a legacy BIOS or a Unified Extensible Firmware Interface (UEFI). The BIOS memory 10 in the verification system 1 may be a read-only memory (ROM), electrically-erasable programmable read-only memory (EEPROM) or flash read-only Memory (Flash ROM). The prescribed biometric data 13 is stored in plurality of physical ROM block of the BIOS memory 10. The system memory 20 may be a random-access memory (RAM) which is used to temporarily store the data or programs required during the aforementioned verification process before running an operation system.

The aforementioned biometric data 31 and prescribed biometric data 13 may be the biometric data related to a fingerprint, a face, a palm texture, an iris, pulse, an ear profile, a voice and so forth. The biometric data capture device 30 utilized in the embodiment of the present invention may be a fingerprint sensor, an image capture device etc. In the embodiment, the Fingerprint Identification Technology (FIT) is applied to compare the prescribed biometric data 13 with the biometric data 31 via the PBA application 12.

The processing module 40 further comprises a biometric application programming interface (biometric API) 41 to update the prescribed biometric data 13 under the environment of the operation system. New biometric data acquired by the biometric capture device 30 is loaded to temporarily store in the system memory 20 by the biometric API 41. The biometric API 41 may encrypt the new biometric data in a specified physical memory block in the system memory 20 for communicating with the BIOS under the environment of the operation system. And the biometric API 41 may further request the BIOS to provide one or more physical memory block in the BIOS memory 10 to store the encrypted new biometric data from the specified physical memory block in the system memory 20 to the physical memory block in the BIOS memory 10 to be new prescribed biometric data for future biometric data verification.

The biometric API 41 may further provide a verification function under the environment of the operation system. The prescribed biometric data 13 and new biometric data acquired by the biometric capture device 30 are both loaded to temporarily store in the system memory 20 by the biometric API 41. The prescribed biometric data 13 and the new biometric data are compared via the biometric API 41. The biometric API 41 may be terminated when the comparing result is matched.

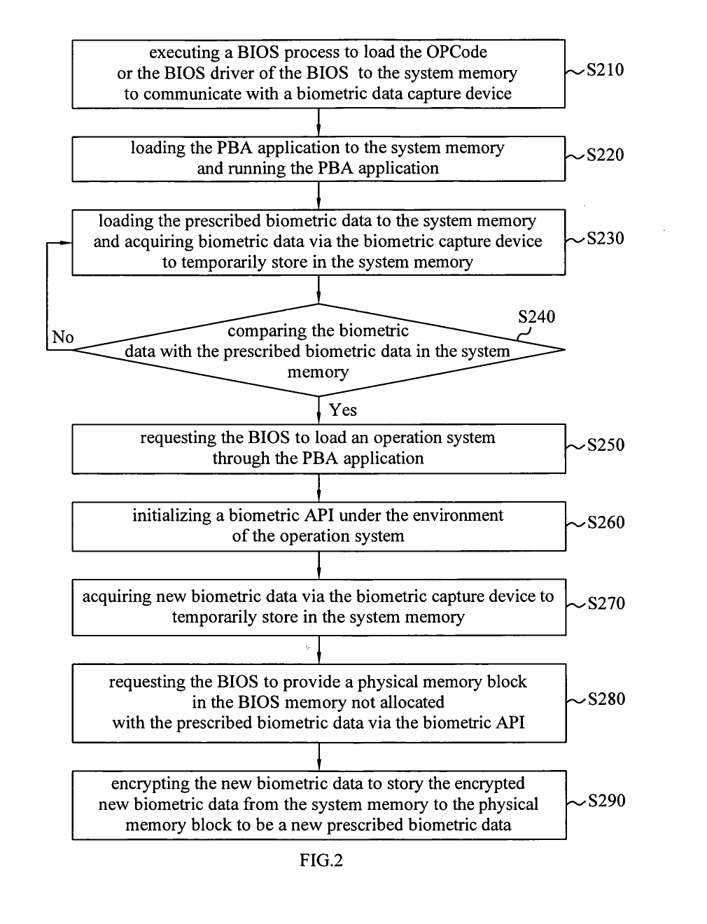

Referring to FIG. 2, illustrated is a flow chart of the implementation steps of a first embodiment of a verification method according to the present invention. The verification method is applicable to an electronic device provided with a system memory and a BIOS memory having a Pre-Boot Authentication (PBA) application and prescribed biometric data. In this figure, the verification method comprises the following steps.

In step S210, a BIOS process is executed to load the OPCode or the BIOS driver of the BIOS from the BIOS memory to the system memory for establishing a communication channel between the electronic device and a biometric data capture device.

In step S220, the PBA application is loaded to system memory for running.

In step S230, the prescribed biometric data and the biometric data acquired by the biometric capture device are loaded to the system memory to temporarily store,

In step S240, the biometric data and the prescribed biometric data are compared via the PBA application. If the comparing result is matched, go to step S250. If not, back to step S230.

In step S250, the BIOS is requested to load an operation system through the PBA application.

In step S260, a biometric application programming interface (biometric API) is initialized under the environment of the operation system.

In step S270, new biometric data acquired by the biometric capture device is temporarily store in the system.

In step S280, a physical memory block in the BIOS memory not allocated within the prescribed biometric data is provided through requesting the BIOS by the biometric API.

In step S290, the new biometric data is encrypted and stored in the physical memory block via the biometric API.

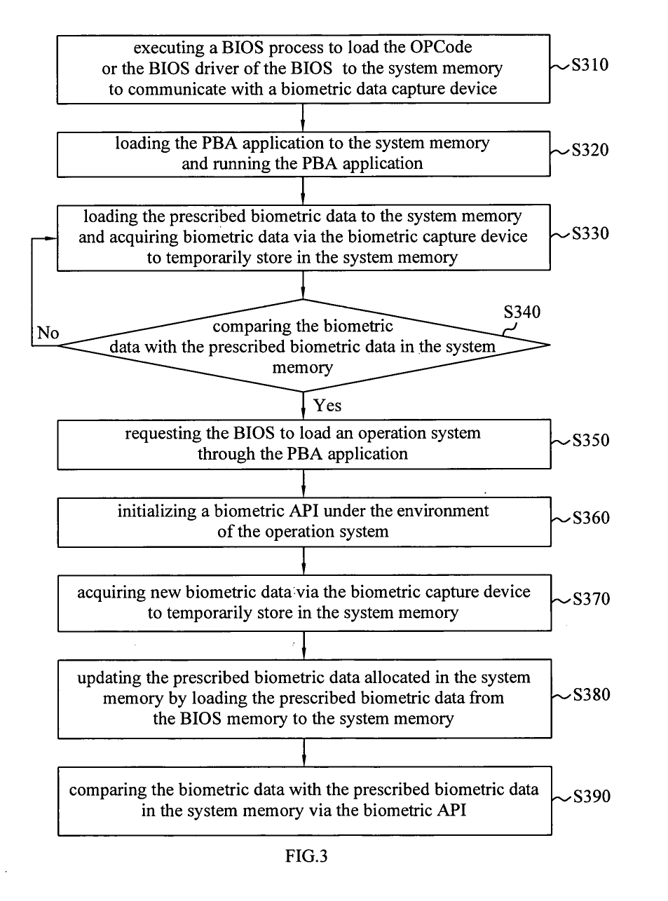

Referring to FIG. 3, illustrated is a flow chart of the implementation steps of a second embodiment of a verification method according to the present invention. The steps S210 to S250 in the first embodiment and the steps S310 to S350 in the present embodiment are the same, hence descriptions thereof are herein omitted for clarity.

In step S360, a biometric application programming interface (biometric API) is initialized under the environment of the operation system.

In step S370, new prescribed biometric data acquired by the biometric capture device is temporarily stored in the system memory.

In step S380, the prescribed biometric data allocated in the system memory is updated by loading the prescribed biometric data from the BIOS memory to the system memory.

In step S390, the biometric data and the prescribed biometric data in the system memory are compared via the biometric API. If the comparing result is matched, terminate the verification process. If the comparing result is not matched, back to step S370

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiment(s) of the present invention.

What is claimed is:

1. A verification method applicable to an electronic device provided with a system memory and a Basic Input/Output System (BIOS) memory having a Pre-Boot Authentication (PBA) application and prescribed biometric data, the verification method comprising the following steps of:
executing a BIOS process to load the operation code (OPCode) or the BIOS driver of the BIOS from the BIOS memory to the system memory for establishing a communication channel between the electronic device and a biometric data capture device;
loading the PBA application to the system memory and running the PBA application;
loading the prescribed biometric data to the system memory and acquiring biometric data via the biometric capture device to temporarily store in the system memory;
comparing the biometric data with the prescribed biometric data in the system memory by utilizing the PBA application; and
requesting the BIOS to load an operation system through the PBA application when the comparing result is matched.

2. The verification method of claim 1, further comprising the step of:
initializing a biometric application programming interface (biometric API) under the environment of the operation system;
acquiring new biometric data via the biometric capture device to temporarily store in the system memory;
requesting the BIOS to provide a physical memory block in the BIOS memory not allocated within the prescribed biometric data via the biometric API; and
encrypting the new biometric data to store the encrypted new biometric data from the system memory to the physical memory block to be new prescribed biometric data.

3. The verification method of claim 1, further comprising the step of:
initializing a biometric application programming interface (biometric API) under the environment of the operation system;
acquiring new biometric data via the biometric capture device to temporarily store in the system memory;
updating the prescribed biometric data allocated in the system memory by loading the prescribed biometric data from the BIOS memory to the system memory;
comparing the biometric data with the prescribed biometric data in the system memory via the biometric API; and
terminating the biometric API when the comparing result is matched.

4. The verification method of claim 1, wherein the BIOS is a legacy BIOS or a Unified Extensible Firmware Interface (UEFI).

5. The verification method of claim 1, wherein the BIOS memory is a read-only memory (ROM), electrically-erasable programmable read-only memory (EEPROM) or flash read-only Memory (Flash ROM).

6. The verification method of claim 1, wherein the system memory is a random-access memory (RAM).

7. The verification method of claim 1, wherein the biometric capture device is a fingerprint sensor or an image capture device.

8. The verification method of claim 7, wherein the PBA compares the biometric data with the prescribed biometric data according to the fingerprint identification technology (FIT).

9. The verification method of claim 1, wherein the biometric data is selected from the group consisting of fingerprint, face, palm texture, iris, pulse, ear profile, and voice.

10. A verification system, comprising:
a BIOS memory being arranged for storing an pre-boot authentication (PBA) application and prescribed biometric data;
a system memory;
a biometric data capture device being arranged for acquiring biometric data;
a processing module connected to the BIOS memory, the system memory and the biometric data capture device, executing a BIOS process to load the operation code (OPCode) or the BIOS driver of the BIOS from the BIOS memory to the system memory to communicate with the image capture device and loading the PBA application from the BIOS memory;
wherein the PBA application in the system memory is run by the processing module to load the prescribed biometric data from the BIOS memory to the system memory and acquire the biometric data to temporarily store in the system memory, and the PBA application compares the biometric data with the prescribed biometric data in the system memory to request the BIOS to load an operation system when the comparing result is matched.

11. The verification system of claim 10, wherein the processing module further comprises a biometric application programming interface (biometric API) to load new biometric data acquired by the biometric capture device to temporarily store in the system memory under the environment of the operation system, the biometric API requests the BIOS to provide a physical memory block in the BIOS memory not allocated within the prescribed biometric data and encrypts the new biometric data to store the encrypted new biometric data from the system memory to the physical memory block to be new prescribed biometric data.

12. The verification system of claim 10, wherein the processing module further comprises a biometric API to load new biometric data acquired by the biometric capture device to temporarily store in the system memory, the biometric API updates the prescribed biometric allocated in the system by loading the prescribed biometric data from the BIOS memory, and compares the biometric data with the new biometric data in the system memory to terminate the biometric API when the comparing result is matched.

13. The verification system of claim 10, wherein the BIOS is a legacy BIOS or a Unified Extensible Firmware Interface (UEFI).

14. The verification system of claim 10, wherein the BIOS memory is a read-only memory (ROM), electrically-erasable programmable read-only memory (EEPROM) or flash read-only Memory (Flash ROM).

15. The verification system of claim 10, wherein the system memory is a random-access memory (RAM).

16. The verification system of claim 10, wherein the biometric capture device is a fingerprint sensor or an image capture device.

17. The verification system of claim 16, wherein the PBA compares the biometric data with the prescribed biometric data according to the fingerprint identification technology (FIT).

18. The verification system of claim 10, wherein the biometric data is selected from the group consisting of fingerprint, face, palm texture, iris, pulse, ear profile, and voice.
